(19) United States
(12) Patent Application Publication
(10) Pub. No.: US 2008/0084007 A1
(43) Pub. Date: Apr. 10, 2008

(54) LOW ASPECT RATIO TIRE CURING BLADDER

(75) Inventor: Walter Szyms, Boca Raton, FL (US)

Correspondence Address: WOOD, HERRON & EVANS, LLP, 2700 CAREW TOWER, 441 VINE STREET, CINCINNATI, OH, 45202, US

(73) Assignee: CARLISLE INTANGIBLE COMPANY, Syracuse, NY (US)

(21) Appl. No.: 11/539,066

(22) Filed: Oct. 5, 2006

(51) Int. Cl. B29C 35/00

(52) U.S. Cl. 264/326; 425/52

(57) ABSTRACT

A tire forming bladder composed of an elastomeric membrane constructed and shaped for curing low aspect ratio tires. The bladder includes clamping feet to enable it to be clamped onto a post for insertion into a tire curing mold. The bladder has a cross-sectional profile where the distance between the clamping feet is less than the distance between the shoulder areas of the bladder. In addition, the shoulder areas of the bladder are of a thinner gauge than the remainder of the bladder membrane and accordingly expands a greater amount than the rest of the bladder membrane when pressurized.

### TECHNICAL FIELD OF THE INVENTION

The present invention relates to bladders used to form tires during a tire curing process, particularly, but not exclusively, to a tire bladder designed for curing low aspect ratio tires.

### BACKGROUND OF THE INVENTION

In recent years, low aspect ratio tires have gained in popularity. The term “aspect ratio” means the value obtained by dividing a tire's section height by its section width when the tire is inflated to maximum air pressure, mounted on the approved measuring rim, and not placed under a load. A low aspect ratio is typically one that is less than 70, whereas a standard aspect ratio for a tire is usually 75 or higher.

Lower aspect ratio tires possess many advantages over standard aspect ratio tires. Lower aspect ratio tires have smaller sidewalls, which more effectively react to lateral forces. In addition, with smaller sidewalls, and thus a lower aspect ratio, less time is required to transmit the steering input from the wheel to the tread. This results in quicker steering response and recovery tire dynamics. The aspect ratio of a tire also affects the tread contact patch. A low aspect ratio tire typically has a wider tread contact patch than does a standard aspect ratio tire, which creates a stiffer footprint that reduces distortion and provides improved cornering and traction.

Due to these advantages, there is a high demand for low aspect ratio tires. However, producing lower aspect ratio tires is more challenging with the present day tire building technology than standard aspect ratio tires. Generally, the same equipment is used to produce low aspect and standard aspect ratio tires. This equipment, however, is not optimized to produce tires having the smaller sidewalls of low aspect ratio tires. Therefore, substandard results are often experienced in the production of lower aspect ratio tires.

For example, in a common method of producing a tire, bead bundles are first built. An inner liner, first and second belts, and a tread are wound around the bead bundles to form a green tire carcass. The green tire carcass is placed into a tire mold and an expandable rubber bladder is inserted into the interior of the green tire carcass. The bladder is pressurized and expands to press the green tire carcass against the mold. The tire mold is heated to form and cure the green tire carcass into the desired final configuration, and includes grooves to form the tread pattern in the tire during the curing process. After the tire has been cured, the bladder is depressurized and removed, and the tire is then removed from the mold.

Problems arise when using a conventional bladder to manufacture a low aspect ratio tire in this process. A conventional bladder has a substantially uniform thickness. As a result, the bladder expands substantially uniformly. This functions well with standard aspect ratio tires, which have a profile that is generally rounded or curved and therefore a conventional bladder is able to accommodate this cross-sectional profile. A low aspect ratio tire, however, has a boxier or more angular cross-sectional profile. This profile requires the bladder to expand a greater amount in the sidewall area than in a standard aspect ratio tire. Conventional bladders are often unable to fully expand in the region of the intersection of the sidewall with the tread. A failure by a conventional bladder to fully engage this area and other areas can result in tires of lackluster quality.

Accordingly, there is a need for a bladder that is able to provide improved contact in the sidewall region of a low aspect ratio tire.

### SUMMARY OF THE INVENTION

One aspect of the present invention is a bladder for curing a low-aspect ratio tire. A first portion of the bladder includes a first clamping foot and a second clamping foot. A second portion of the bladder includes a first shoulder area and a second shoulder area. The shoulder areas of the bladder have a respective first and second gauge of thickness. A third portion of the bladder connects the first portion to the second portion and has a third gauge of thickness. In addition, the first and second gauges of thickness are less than the third gauge of thickness.

Another aspect of the invention is a bladder for curing a low aspect ratio tire. Clamping feet are positioned at a first distance from each other in the bladder. A first shoulder portion and a second shoulder portion are arranged a second distance from each other. The first and second shoulder portions are of a thinner gauge than the remainder of the bladder. In addition, the second distance is greater than the first distance.

A further aspect of the invention is a bladder for curing a low-aspect ratio tire by pressurizing the bladder. The bladder includes a centerline. In addition, the bladder includes a first zone of expansion located in the shoulder portions positioned on opposite sides of the centerline of the bladder. The bladder also includes a second zone of expansion located along a central portion positioned between the shoulder portions of the bladder and passing through the centerline. Moreover, the first zone of expansion expands a greater amount under pressure than does the second zone of expansion.

Yet another aspect of the invention is a method for forming a low-aspect ratio tire. The method includes the steps of placing a low aspect ratio tire carcass inside of a mold adapted to increase temperature and having an interior surface. Another step is inserting a bladder inside of the mold and the low aspect ratio tire carcass. A further step is pressurizing the bladder inside of the low aspect ratio tire carcass. The bladder includes shoulder portions that expand a greater amount under pressure than the remainder of the bladder. Moreover, the shape of the bladder generally conforms to the profile of the low aspect ratio tire carcass. An additional step is pressing the low aspect ratio tire carcass against the interior surface of the mold with the pressurized bladder. Another step is raising the temperature of the mold. A further step is molding the low aspect ratio tire carcass into a tire.

### BRIEF DESCRIPTION OF THE DRAWINGS

The accompanying drawings illustrate an embodiment of the invention and, together with a general description of the invention given above and a detailed description of a preferred embodiment given below, serve to explain the invention.

FIG. 1 illustrates a perspective view of a tire forming bladder according to one embodiment of the present invention;

FIG. 2 illustrates a cross-sectional view of the bladder illustrated in FIG. 1;

FIG. 3A illustrates a schematic cross-sectional view of the bladder of FIG. 1 being used in a tire mold to form a low aspect ratio tire;

FIG. 3B illustrates the tire bladder of FIG. 3A in which the bladder has expanded under pressure causing preferential contact between the sidewall portion of a green tire carcass and a tire mold;

FIG. 3C illustrates a schematic cross-sectional view of the tire bladder of FIG. 3B with increased expansion of the bladder causing full contact between a green tire carcass and a tire mold; and

FIG. 4 illustrates a prior art bladder design.

### DETAILED DESCRIPTION OF THE DRAWINGS

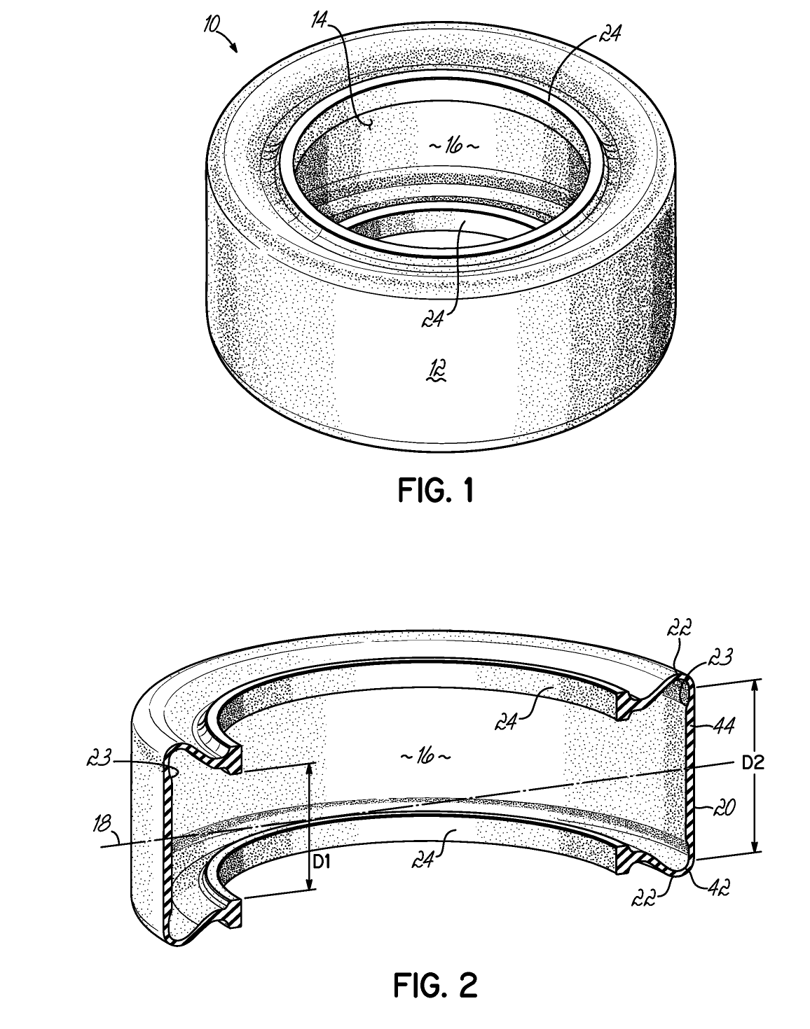

Referring now to FIG. 1, a preferred embodiment of a bladder 10 for forming a low aspect ratio tire is illustrated. In some embodiments, the aspect ratios produced are in the 45 series, the 40 series, and the 30 series, however, other series of low aspect ratio tires can be produced. The bladder 10 is formed of a flexible and expandable material, such as an elastomeric material, including butyl rubber. However, other types of materials apparent to those skilled in the art can be utilized to form the bladder 10. The bladder 10 can be formed using an injection molding process or other manufacturing technique readily apparent to those skilled in the art.

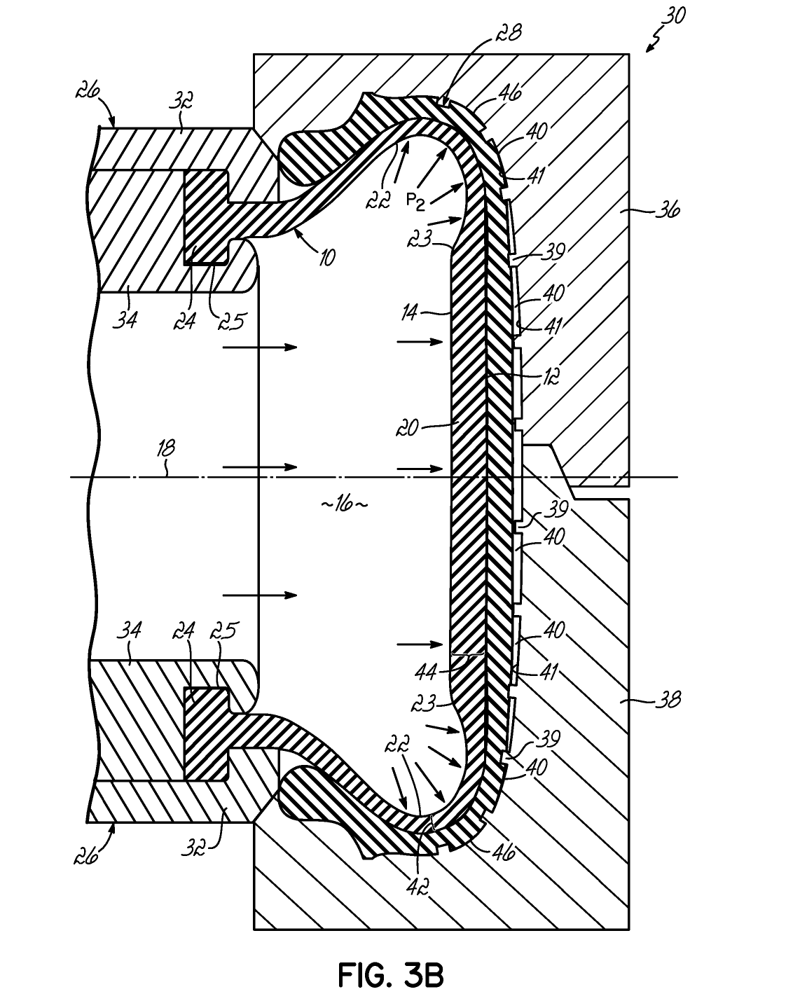

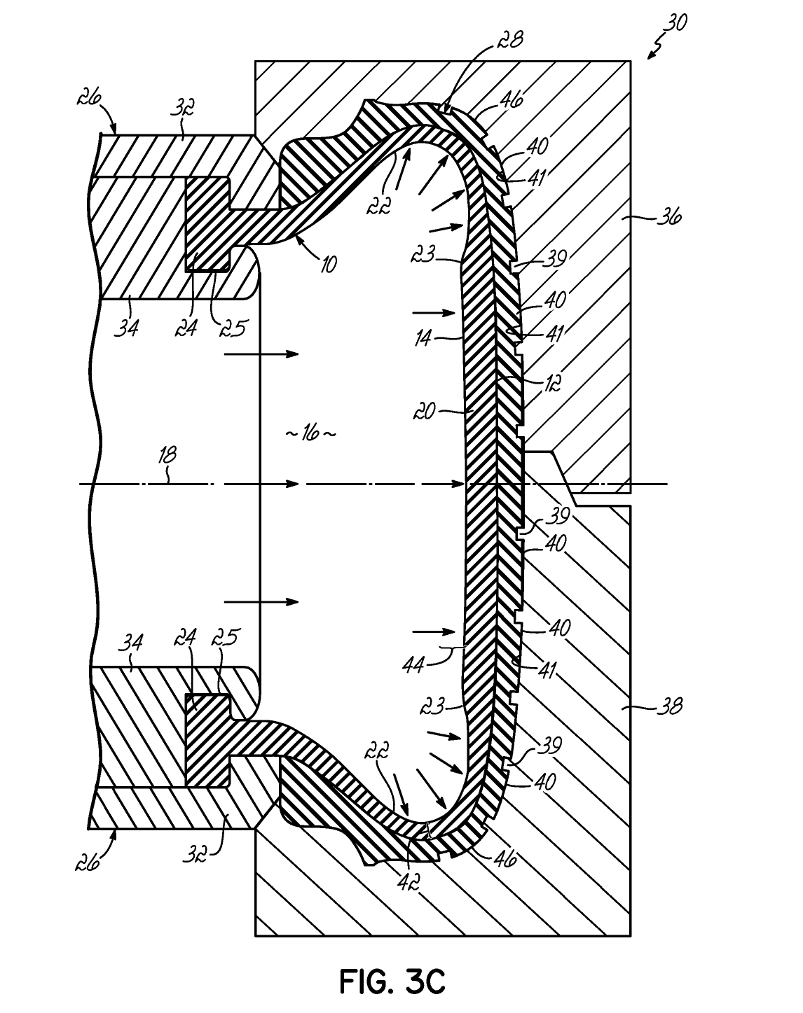

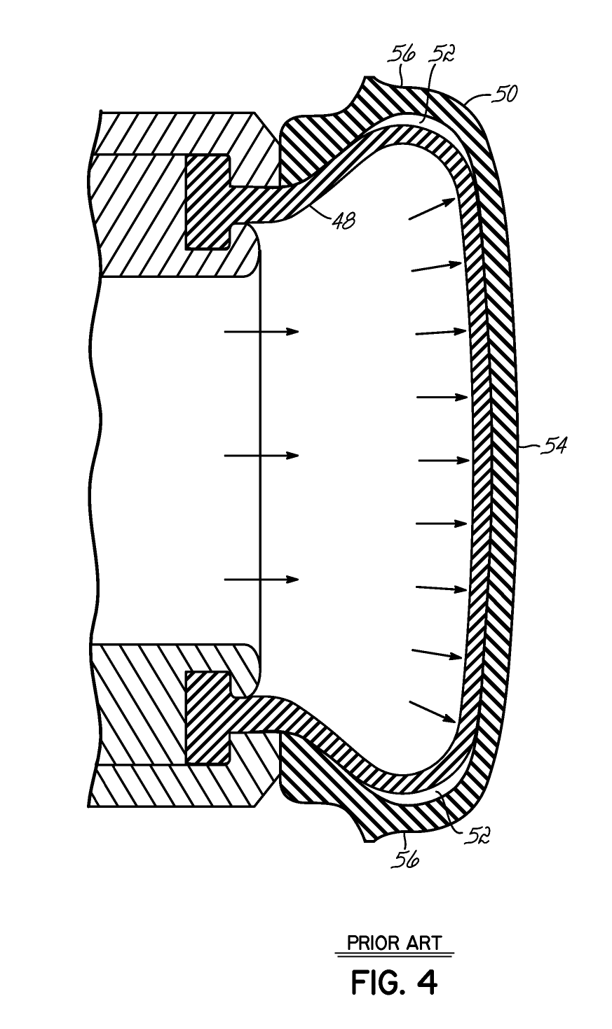

In the illustrated embodiment, the bladder 10 has a generally toroidal shape that generally corresponds to the shape of a low aspect ratio tire and that has an exterior surface 12 and an interior surface 14. The exterior and interior surfaces 12, 14 define an interior space 16 arranged to receive a central post (not shown) of a tire mold 30 (FIG. 3). The bladder 10 is connected to the post (not shown), usually by clamping, and is then inserted into the tire mold 30. The bladder 10 is designed to be pressurized during the process of forming/curing a tire and to expand under that pressure to engage a green tire carcass thereby urging the green tire carcass into contact with the tire mold 30.

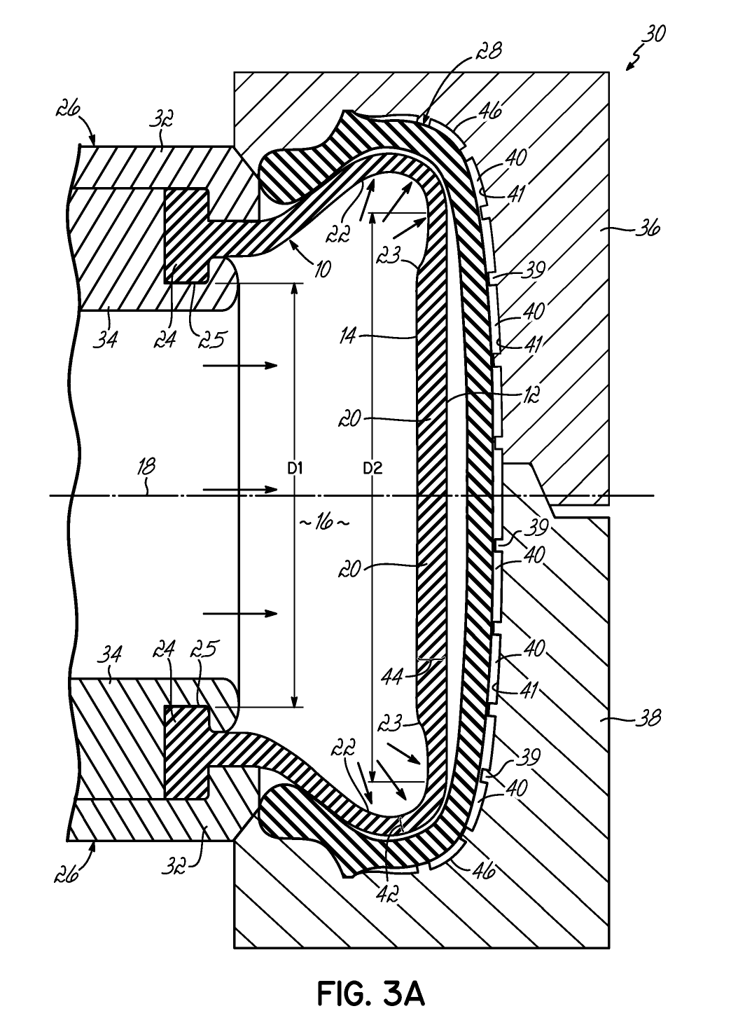

FIG. 2 illustrates the three main portions of the bladder 10 positioned around the centerline 18 of the bladder 10. The first portion of the bladder 10 is a generally rectilinear and generally uniform thickness central portion 20 that extends axially outward from the centerline. In one preferred embodiment, the thickness or gauge of the central portion 20 is about 5 millimeters. The second portion of the bladder 10 extends from each of the ends of the central portion 20 and includes the shoulder portions 22 which are symmetrically positioned on either side of the centerline 18 and which have a generally arcuate cross section. The shoulder portions 22 begin at a location 23 where the thickness of the cross section of the bladder 10 is reduced. In one preferred embodiment, the thickness of the shoulder portions 22 is about 4 millimeters. The shoulder portions 22 are the portions of the bladder 10 that engage the transitional portion of the finished tire between the treads and sidewall.

The third portion of the bladder 10 is the clamping feet 24. The clamping feet 24 are used to secure the bladder 10 to a post (not shown) that is inserted into the center of the tire mold 30. The distance between the interior surface 25 of clamping feet 24 is represented by D1 in FIGS. 2 and 3A and the distance along the generally rectilinear portion of the exterior surface 12, which includes the central portion 20 and part of the shoulder portions 22, is represented by D2. Preferably, the distance D1 is less than the distance D2, which provides a wide rectilinear section of the exterior surface 12 that is longer in length than the distance between the clamping feet 24. In one preferred embodiment, the distance D1 is about 5.75 inches and the distance D2 is about 7.5 inches.

The central portion 20, shoulder portions 22, and clamping feet 24 are preferably one continuous membrane that is both expandable and readily deformable. The shape defined by the combination of portions 20 and 22 conforms generally to the profile of a low aspect ratio tire. Although clamping feet 24 are shown as having a cross-sectional width greater than that of the central portion 20 and shoulder portions 22, the present invention is not limited to such a construction. Those skilled in the art will recognize that other constructions may be used so long as the bladder 10 may be secured in position in the mold 30.

FIG. 3A illustrates the beginning stages of the curing process before the bladder is pressurized of a low aspect ratio tire using the bladder 10 illustrated in FIGS. 1 and 2. The bladder 10 attaches to the post (not shown) using dual clamps 26 positioned opposite from one another that serve to restrain the bladder 10 during the curing process. After the bladder 10 is attached to the post, it is inserted into a green tire carcass 28, both of which are placed in a mold 30. Advantageously the shape of the bladder 10 generally conforms to the shape of the green tire carcass 28, which improves the curing process of the green tire carcass 28 as described below.

During curing, the clamps 26 hold the bladder 10 inside of the mold 30 with each of the clamps 26 having an outside clamp 32 and an inside clamp 34 to clamp around the clamping feet 24. The green tire carcass 28 is surrounded by the mold 30, which has a top half 36 and a bottom half 38 that can move apart relative to each other enabling removal or placement of the green tire carcass 28. The mold 30 also includes ribs 39 and grooves 40 formed on the interior surface 41 of the mold 30 to form the treads and tread grooves on the green tire carcass 28 during the curing process. Besides the two-piece mold 30 illustrated in FIG. 3A, a variety of other types of molds can be utilized in forming the green tire carcass 28. For instance, segmental molds are commonly utilized in forming low aspect ratio tires.

As illustrated in FIG. 3B, after the green tire carcass 28 is positioned in the mold 30, the bladder 10 is pressurized. As the pressure is increased inside of the bladder 10, as illustrated by the arrows, the shoulder portions 22 which have a cross-sectional thickness or first gauge 42 that is thinner than the cross-sectional thickness or second gauge 44 of the central portion 20 of the bladder 10, expand at a faster rate than the central portion 20. The central portion 20 having the thicker second gauge 44 will stretch and expand at a slower rate than shoulder portions 22 having the thinner first gauge 42. Advantageously, the expansion at the shoulder portions 22 results in increased pressure on the green tire carcass 28 in the corner areas 46 of the green tire carcass 28 as compared to bladders used to form standard aspect ratio tires. This increased pressure in the corner areas 46 results in an improved quality and uniform contact between the green tire carcass 28 and the mold 30 in the corner areas 46 and, thereby, higher quality low aspect ratio tires are obtained than can be obtained using traditional bladders.

Referring now to FIG. 3C, the fully pressurized bladder 10 is illustrated pressing the green tire carcass 28 against the entire surface of the mold 30. Because the bladder 10 expands more rapidly in the shoulder portions 22 than the central portion, the bladder 10 is able to urge the green tire carcass 28 into full engagement with the mold 30 without any gaps. The result is a uniformly formed low aspect ratio tire created from the green tire carcass 28. Although the preferred embodiment achieves the desired results by reducing the thickness or gauge 42 of the bladder 10 in the shoulder portions 22 as compared to the thickness or gauge 44 of the central portion 20, the present invention is not limited to such a construction. For example, the bladder 10 could be formed such that the material in the shoulder portions 22 has a lower modulus of elasticity than the material in the central portion 20 such that the shoulder portions 22 expand at a greater rate than does the central portion 20 under a given pressure. Persons skilled in the art will recognize that other variations are available that enable the shoulder portions 22 of the bladder 10 to expand more readily under a given pressure than the central portion 20.

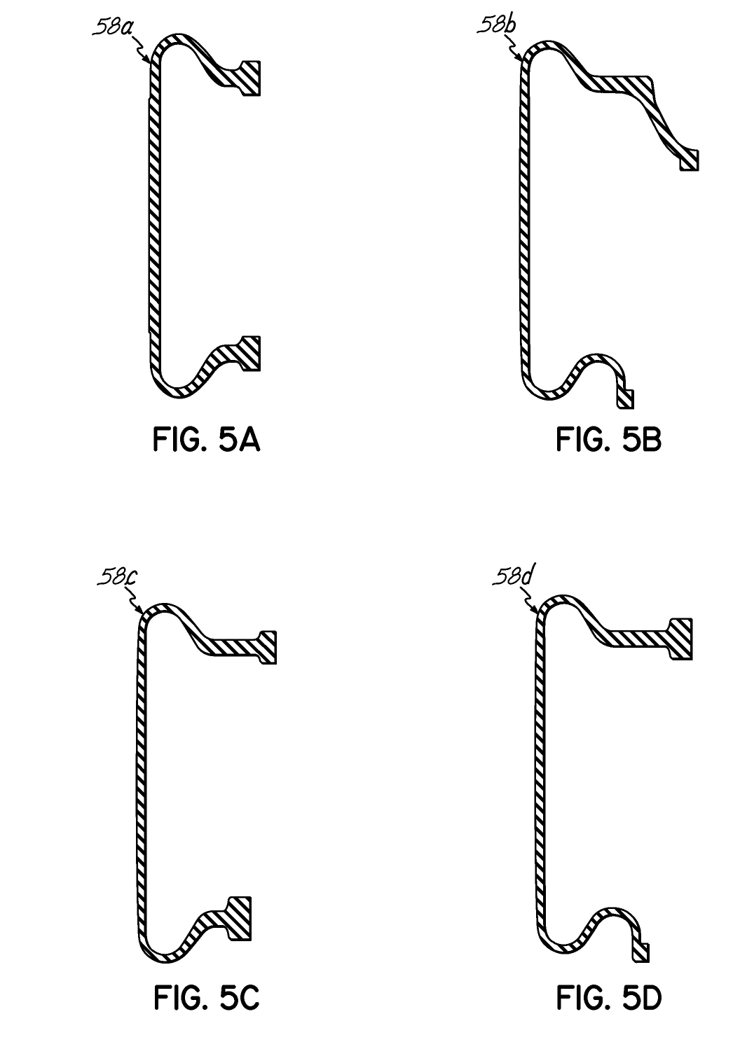

Referring now to FIG. 4, the advantage of the bladder 10 of the present invention over a conventional bladder 48 is illustrated. Since the conventional bladder 48 has a generally uniform gauge, it fails to adequately expand across and conform to all areas of the green tire carcass 50. Instead, a gap area 52 is frequently left between the bladder 48 and the green tire carcass 50 in the corner areas between the tread area 54 and sidewall areas 56. The result is that the transitional part of the green tire carcass 50 from the tread area 54 to the sidewall area 56 is frequently poorly formed. The conventional bladder 48 therefore produces low aspect ratio tires of marginal quality for at least the reason that the pressure applied to the shoulder areas of the bladder 48 is inadequate.

Referring now to FIGS. 5A-D, multiple bladder embodiments are illustrated for use with different types of tire molds. The first bladder embodiment 58a is directed to a bladder for use with Bag-O-Matic® type LARC curing presses. The profile of this bladder is similar to the one described in FIGS. 1-4. The second bladder embodiment 58b is directed to another type of bladder for use with a NRM type LARC curing press. This bladder has a profile with an irregularly shaping clamping foot and a curved clamping foot. The third bladder embodiment 58c is directed to another type of bladder for use with KRUPP & AUTOLOK LARC curing presses. This bladder has a profile with an extended clamping foot and a thick clamping foot. The fourth bladder embodiment 58d is directed to yet another type of bladder for use with KOBE type LARC curing presses.

The invention has been described in the context of exemplary embodiments. Those skilled in the art will appreciate that additions, deletions and modifications to the features described herein may be made without departing from the principles of the present invention. Accordingly, the following is claimed:

1. A bladder for curing a low-aspect ratio tire comprising:
a first portion including a first clamping foot and a second clamping foot;
a second portion including a first shoulder area and a second shoulder area, the first and second shoulder areas having a respective first and second gauge of thickness; and
a third portion connecting the first portion to the second portion and having a third gauge of thickness, wherein the first and second gauge of thickness are less than the third gauge of thickness.

2. The bladder of claim 1 wherein the first and second gauge of thickness are substantially identical.

3. The bladder of claim 1 wherein the distance separating the first and second clamping feet is less than the length of the third portion.

4. The bladder of claim 1 wherein the first, second, and third portions comprise portions of a continuous membrane.

5. The bladder of claim 4 wherein the membrane is curved through the first and second shoulder areas.

6. The bladder of claim 4 wherein the membrane is substantially straight through the third portion.

7. The bladder of claim 4 wherein at least one clamping foot is of a thickness greater than the membrane in the first and second shoulder areas.

8. The bladder of claim 1 wherein the shoulder areas have greater elasticity than the third portion.

9. The bladder of claim 1 wherein the bladder is butyl rubber.

10. A bladder for curing a low-aspect ratio tire comprising:
a bladder including clamping feet positioned at a first distance from each other and a first shoulder portion and a second shoulder portion a second distance from each other, wherein the first and second shoulder portions are of a thinner gauge than the remainder of the bladder and wherein the second distance is greater than the first distance.

11. The bladder of claim 10 wherein the bladder is a membrane.

12. The bladder of claim 11 wherein the membrane expands a greater amount at the shoulder portions than the remainder of the bladder when the bladder is placed under pressure.

13. The bladder of claim 11 wherein the membrane is butyl rubber.

14. A bladder for curing a low-aspect ratio tire by pressurizing the bladder, the bladder including a centerline and comprising:
a first zone of expansion located in shoulder portions positioned on opposite sides of the centerline of the bladder; and
a second zone of expansion located along a central portion passing through the centerline and positioned between the shoulder portions of the bladder;
wherein the first zone of expansion expands a greater amount under pressure than does the second zone of expansion.

15. The bladder of claim 14 wherein the bladder is a membrane.

16. The bladder of claim 14 wherein the bladder includes clamping feet that are constructed and arranged to be positioned closer together on opposite sides of the centerline than the shoulder portions.

17. A method for forming a low-aspect ratio tire comprising:
placing a low aspect ratio tire carcass inside of a mold adapted to increase temperature and having an interior surface;
inserting a bladder inside of the mold and the low aspect ratio tire carcass;
pressurizing the bladder inside of the low aspect ratio tire carcass, the bladder having shoulder portions that expand a greater amount under pressure than the remainder of the bladder, wherein the shape of the bladder generally conforms to the profile of the low aspect ratio tire carcass;
pressing the low aspect ratio tire carcass against the interior surface of the mold with the pressurized bladder;
raising the temperature of the mold; and
molding the low aspect ratio tire carcass into a tire.

18. The method of claim 17 wherein the tire bladder is a membrane wherein the gauge of the shoulder portions is thinner than the gauge of the remainder of the tire bladder.

19. The method of claim 17 wherein the interior surface includes ribs to form tread grooves or other patterns in the low aspect ratio tire carcass.

20. The method of claim 17 wherein the bladder includes clamping feet.
